(19) United States
(12) Patent Application Publication
(10) Pub. No.: US 2021/0323673 A1
(43) Pub. Date: Oct. 21, 2021

(54) MODULAR PAYLOAD TRANSPORT SYSTEM FOR AIR VEHICLES

(71) Applicant: Air Assist America Air Ambulance LLC, Palm City, FL (US)

(72) Inventors: Pushpinder Parmar, Palm City, FL (US); Michael Keister, Palm City, FL (US)

(21) Appl. No.: 17/356,094

(22) Filed: Jun. 23, 2021

Related U.S. Application Data
(63) Continuation of application No. PCT/US2019/068285, filed on Dec. 23, 2019.
(60) Provisional application No. 62/787,124, filed on Dec. 31, 2018.

(51) Int. Cl. B64D 9/00; A61G 1/06

(52) U.S. Cl. CPC B64D 9/003; A61G 1/06

(57) ABSTRACT

A modular payload transport system is described for the releasable coupling of a payload to a support structure. The payload transport system may be adaptable to multiple modes of transportation to create a flexible and portable system for securing a payload. In some embodiments, the payload transport system may consist of a portable medical stretcher and a coupling system that secures the stretcher to a transportation vehicle such as an aircraft.

### CROSS-REFERENCE

This application is a continuation application of International Application No. PCT/US2019/068285, filed on Dec. 23, 2019, which application claims the benefit of U.S. Provisional Patent Application No. 62/787,124, filed Dec. 31, 2018, which is incorporated herein by reference in their entirety for all purposes.

### BACKGROUND

The transportation of a payload may necessitate a safe and secure system for retaining the payload. Payloads may comprise a broad spectrum of living, non-living, and inanimate objects. Differing payloads may have different requirements regarding their mode of transportation. For example, a non-living payload of fragile consumer goods may require tight retention of the payload to prevent disturbance while the payload is moved. By contrast, moving a living payload such as a medical patient on a stretcher may require a measure of flexibility in the restraints or harnesses for the comfort and safety of the patient.

A payload in transit may move through multiple modes of transportation. For example, cargo may arrive at port on a sea vessel and then be transferred to a motor vehicle or a train. It is preferable to have payloads retained in a transport system that allows them to be moved in a modular fashion where the payload is portable between modes of transportation without necessitating a change in the system retaining the payload.

### SUMMARY

The present disclosure describes modular systems for retaining a portable payload during transportation. The modular payload system may comprise one or more components that connect to releasably secure a payload to a base support in a transportation vehicle. The payload support system may utilize a quick-release mechanism to allow rapid coupling and decoupling of the payload to the other components of the system. The payload transport system may be designed to provide a highly flexible system that can be adapted to multiple modes of transportation so that a payload can have increased portability. In some embodiments, the present disclosure may describe a portable stretcher system that can be mounted to an aircraft bench seat, creating a secure payload transport system that utilizes the existing hardware of an aircraft. The aircraft payload transport system may be adaptable to other modes of transportation, such as gurneys or ambulances, to create a system for patient transport that allows the patient to remain comfortably secured to a single platform instead of having to transfer between beds, gurneys, and stretchers.

In an aspect, a modular payload transport system is provided, comprising a base support configured to be releasably coupled to a mounting assembly via a first coupling, the mounting assembly configured to be releasably coupled to the base support via the first coupling and configured to be releasably coupled to a payload mounting platform via a second coupling, and the payload mounting platform configured to be releasably coupled to the mounting assembly and configured to retain a portable payload, wherein the base support, the mounting assembly, and the payload mounting platform are connected to form a modular payload transport system.

In some embodiments, the modular payload system further comprises a transportation vehicle. In some embodiments, the transportation vehicle comprises a motor vehicle, aircraft, or sea vessel. In some embodiments, the aircraft comprises a private jet airplane.

In some embodiments, the mounting assembly may be releasably coupled to a first base support or a second base support, wherein the base support differs from the second base support.

In some embodiments, the base support comprises an airplane bench seat. In some embodiments, the payload mounting platform comprises a medical stretcher.

In some embodiments, the modular payload transport system further comprises the portable payload. In some embodiments, the portable payload comprises a medical patient. In some embodiments, the portable payload comprises cargo, a scientific instrument, or a medical device.

In some embodiments, the base support further comprises an electrical outlet, wherein the electrical outlet is connected to an electrical power supply from the transportation vehicle.

In some embodiments, the coupling comprises a first base coupling and a second base coupling. In some embodiments, the mounting assembly comprises a first insert post configured to connect to the first coupling, and a second insert post configured to connect to the second coupling.

In another aspect, a method of securing a payload unit to form a modular payload transport system is provided, comprising providing a base support comprising a first coupling and a second coupling, providing a payload unit comprising a mounting assembly and a payload mounting platform, connecting the payload unit to the first coupling, and connecting the payload unit to the second coupling, thereby securing the payload unit to the base support to form a modular payload transport system.

In some embodiments, the mounting assembly comprises a first insert post and a second insert post. In some embodiments, the first insert post connects to the first coupling, and the second insert post secures to the second coupling.

In some embodiments, the connecting the payload unit to the first coupling comprises connecting the first insert post to the first coupling. In some embodiments, the connecting the payload unit to the second coupling comprises connecting the second insert post to the second coupling. In some embodiments, the connecting the payload unit to the first coupling occurs before the connecting the payload unit to the second coupling. In some embodiments, the connecting the payload unit to the first coupling occurs simultaneously with the connecting the payload unit to the second coupling. In some embodiments, the connecting the payload unit to the second coupling comprises rotating the payload unit about the first insert post and connecting the second insert post to the second coupling.

In some embodiments, the method further comprises disconnecting the first insert post from the first coupling or disconnecting the second insert post from the second coupling.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings (also “Figure” and “FIG.” herein), of which:

FIG. 1 illustrates a lateral exploded view of a modular payload transport system for converting an aircraft bench seat into a portable medical stretcher.

FIG. 2 illustrates a forward exploded view of a modular payload transport system for converting an aircraft bench seat into a portable medical stretcher.

FIG. 3 depicts an image of an aircraft bench seat that has been modified to act as a base support for a portable medical stretcher.

FIG. 4 shows a detailed image of compartments in the base support of a portable aircraft medical stretcher system.

FIG. 5 displays a base support consisting of an aircraft bench seat connected to a mounting assembly for retaining a portable medical stretcher.

FIG. 6 shows a mounting assembly attached to an aircraft bench seat with a cushion installed as part of a portable stretcher system.

FIG. 7 depicts a payload mounting platform consisting of a portable medical stretcher securely connected to a mounting assembly on an aircraft bench seat.

FIG. 8 displays an image of a fully assembled payload transport system that forms a portable medical stretcher for an aircraft.

FIG. 9 shows a portable medical stretcher in an upright position after assembly of the payload transport system has been completed.

FIG. 10 shows the face of a utility compartment in the base support of an aircraft medical stretcher system.

FIG. 11 depicts an image of the inner volume of a utility compartment in the base support of a medical stretcher system for an aircraft.

FIG. 12 illustrates a cross-sectional view of a guide insert for installing a mounting assembly used with a portable aircraft medical stretcher system.

FIG. 13A illustrates a uniaxial alignment of attachment mechanisms for loading a payload mounting platform on the mounting assembly.

FIG. 13B illustrates a unilateral alignment of attachment mechanisms for loading a payload mounting platform on the mounting assembly.

FIG. 13C illustrates a bilateral alignment of attachment mechanisms for loading a payload mounting platform on the mounting assembly.

FIG. 14 depicts a hypothetical wiring route for connecting an aircraft payload support system to the aircraft's main power box.

FIG. 15 shows a mechanical drawing of an electrical connector for an aircraft base support power system.

FIG. 16 illustrates a four-step process for sealing the cylindrical connector for an electrical power system to the base support using epoxy.

### DETAILED DESCRIPTION

While preferable embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Provided herein are devices and methods for transporting an object in a vehicle using a secure, modular payload system. For example, the present disclosure may provide a description of a stretcher system for transporting a medical patient on a private airplane, such as a Gulfstream jet. The payload system may be designed to work across a variety of vehicle systems with a minimum of required customization by utilizing a standardized system of modules and adapaters. The system may be designed for rapid and secure coupling and uncoupling of the payload, allowing simple and safe transport of an object, and the universal attachment mechanisms eliminate the need for transfers between payloads when moving from one vehicle to another. For example, a patient with a spinal cord injury could be fully secured to a single stretcher system across a complicated extraction that involves helicopter, ambulance, and airplane transports where conventional methods might have involved the transfer of the patient onto a separate stretcher for each vehicle.

The systems, devices, and methods of the present invention provide improved payload mounting platforms that enable a payload to be interchangeably coupled to a plurality of different types of base supports. The base support can be a movable object (e.g., a stretcher cart), a fixed object (e.g. the base of a couch on a private aircraft), or any other device for supporting the payload. In some embodiments, the mounting platforms described herein include electrical couplings permitting transmission of electricity, computer signals, or other transmissions between the base support (and/or a movable object coupled thereto) and the payload. Advantageously, the mounting platform of the payload can be quickly coupled to and/or decoupled from the base supports, thereby enabling the payload to be used interchangeably with a wide variety of base supports.

For example, a modular mounting platform can be used to mount a stretcher to the base of a couch on a private aircraft. The mounting platform may be operable to allow securing of the payload from a broad range of angles with two axes of freedom to positionally control coupling and decoupling. Additionally, when desired, the mounting platform can be rapidly decoupled from the base support, permitting simple and stable removal of a payload from the coupling mechanism.

Thus, in one aspect, the present invention provides a platform for interchangeably mounting a payload to a base support. In some embodiments, the platform includes a payload mounting platform configured to be releasably coupled to a payload, a mounting assembly configured to be releasably coupled to a base support, and a means of connection that couples the payload mounting platform to the mounting assembly. The payload mounting platform can be configured to control a spatial disposition of the payload (e.g., position, orientation). The mounting assembly can be configured to couple a plurality of types of base supports, such as at least two different types of base supports. Examples of base supports include couch bases on private aircraft, rearward compartments in large sports utility vehicles and ambulances, and helicopter bays. In contrast to existing approaches in which different base supports require different mounting platforms or customized installation spaces, the disclosed platform can be used interchangeably with many different types of base supports, thus improving flexibility and convenience for the user.

Furthermore, the payload mounting platform can be electrically coupled to the base support. The electrical couplings of payload mounting platform and base support can enable transmission of electricity or data between the payload and the base support. The electrical couplings may enable the payload mounting assembly and/or payload to be powered by the base support. In some embodiments, the payload mounting platform may comprise a stretcher and electrical transmission may be used to provide power to controls for adjusting the orientation of a medical patient, e.g. hydraulics to elevate a patient's torso and head. Furthermore, connectivity between the payload mounting platform and the base support may allow the transmission of data. In some embodiments, medical instrumentation such as blood pressure and heart rate monitors may be coupled between a patient and computers within the base support structure.

In another aspect, the present invention provides a method for interchangeably mounting a payload. The mounting platform can be releasably coupled to a first base support. The method includes decoupling the mounting platform from the first base support, followed by coupling the mounting platform to a second base support different from the first base support via a releasable coupling. An example may be the release of a stretcher from a gurney cart and the subsequent coupling of the stretcher to a base support in a private aircraft. The base supports described above are equally applicable to these embodiments. The couplings may be electrical couplings enabling transmission of power or data between the payload (e.g., vital signs from a monitoring device) and at least one of the first or second base supports, as previously mentioned.

A payload of the present invention can include non-living entities (e.g., cargo, equipment, instruments) as well as living entities (e.g., medical patients). The payload may not perform any operation or function, such as fragile cargo in transport. Alternatively, the payload can be a payload configured to perform an operation or function, also known as a functional payload, such as scientific instrumentation. For example, the payload can include one or more instruments for testing in reduced gravity. A payload may comprise other objects such as movable, modular furniture that are attached via couplings to the base supports. In biomedical applications, the payload system may comprise other features, such as biohazard containment. Payload systems may also be adapted to accommodate further biomedical applications such as emergency surgical equipment for air, sea, and land-borne vehicles.

The payload may be stabilized so as to reduce vibrations or other unwanted motions that may interfere with the payload operation. In some instances, the entire payload may be stabilized. Alternatively, some portions of the payload may be stabilized, while other portions may not be stabilized. For example, the payload mounting support may include some degree of shock absorption while the base support is not stabilized.

In some embodiments, the payload can be carried by a suitable base support. The base support can be configured to support some or all of the weight of the payload. As previously mentioned, the base support can be a movable object, examples of which are described in further detail elsewhere herein. Alternatively, the base support can be an adapter (e.g., a rack, frame, holder, mount, cradle, bracket, plate, handle, etc.) configured to be fixed, coupled to and/or carried by a movable object. Exemplary embodiments of suitable base supports are provided below.

The payload mounting platform can be coupled to the base support using a mounting assembly. The payload mounting platform may be integrally formed with the mounting assembly. Alternatively, the payload mounting platform may be provided separately from and coupled to the mounting assembly. The coupling may be a permanent coupling or a releasable coupling. For example, the payload mounting platform may be coupled to the mounting platform using fasteners (e.g., screws, nuts, bolts, pins), interference fits, snap fits, and the like. The coupling may fix the payload at specified position and/or orientation relative to the mounting platform. Alternatively, the coupling may permit movement of the payload mounting platform with respect to the mounting assembly (e.g., with up to four axes of freedom of motion).

The mounting platform can be coupled to the base support, either directly or indirectly, and the coupling may be a permanent coupling or a releasable coupling. Exemplary coupling mechanisms are described in further detail elsewhere herein. Any description herein pertaining to couplings between a payload mounting platform and a mounting assembly can also be applied to couplings between a base support and the mounting assembly, and vice-versa. The coupling between the base support and the mounting assembly may permit motion of the mounting assembly relative to the base support (e.g., up to two axes of freedom in translation and one axis of freedom in rotation). Alternatively, the spatial disposition of the mounting assembly may be fixed relative to the base support.

In some embodiments, the payload mounting support or the mounting assembly may be able to move translationally or rotationally relative to the base support, altering the position of the payload relative to the base support. In other embodiments, the base support may be capable of rotational or translational movement, altering the position of the payload by moving the entire payload-bearing system. In some embodiments, the payload mounting platform can be adapted to reduce or prevent certain movements of the payload. For example, the payload mounting platform may include one or more stabilizing elements (e.g. dampers) for reducing or eliminating unwanted motions of the payload (e.g. shaking or vibration of a medical patient during flight turbulence).

Most embodiments will comprise at least three major components: i) a base support, ii) a mounting assembly, and iii) a payload mounting platform. The modular nature of the system supports a wide variety of configurations of payload mounting platforms with mounting assemblies, and mounting assemblies with base supports. The wide variety of configurations yields a system that is highly flexible and portable to meet a variety of needs in a variety of environments.

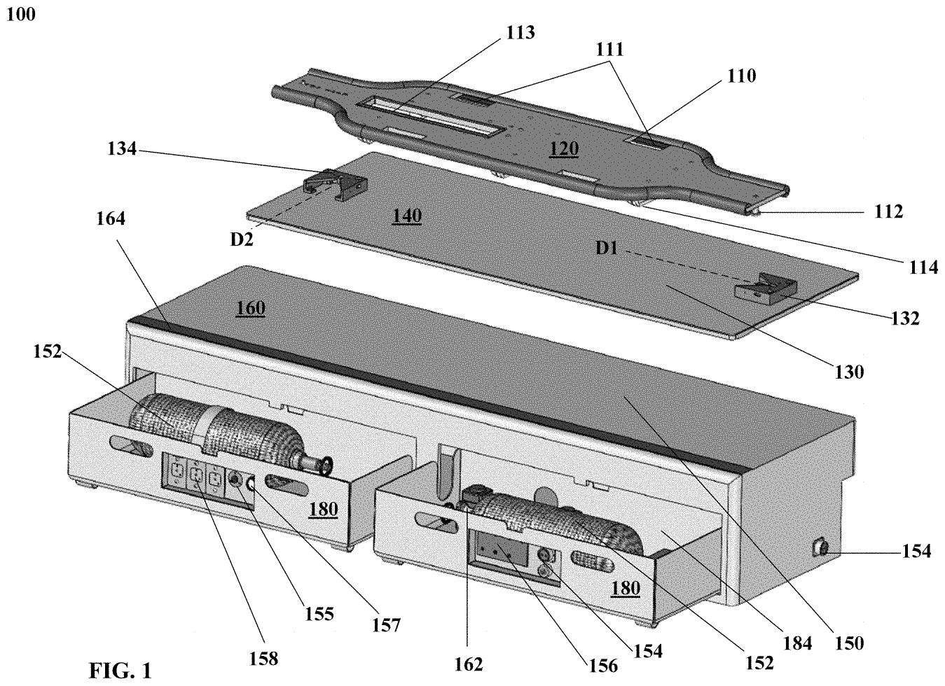

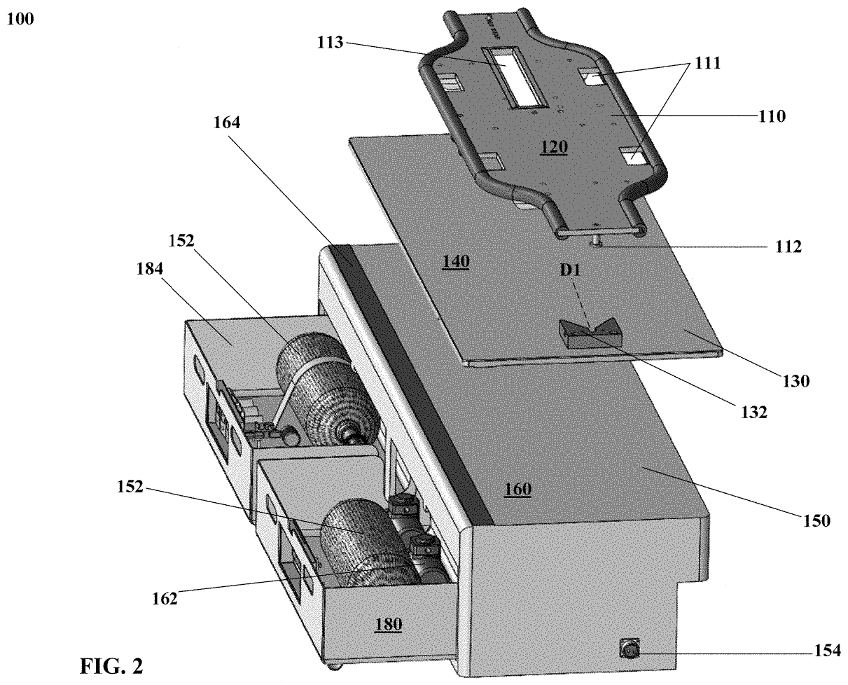

A particular embodiment of a modular payload system is depicted in FIGS. 1 and 2. These figures depict an exploded view of how the three main components of a medical stretcher system 100 for a private aircraft lie with respect to each other. In FIGS. 1 and 2, a payload mounting platform 110 is connected to a mounting assembly 130. Two locking insert posts 112 are connected to the payload mounting platform 110. The locking insert posts 112 are secured by a head-side keyhole locking mechanism 132 and a foot-side keyhole locking mechanism 134. The head-side keyhole locking mechanism 132 and foot-side keyhole locking mechanism 134 are connected to the substantially horizontal top surface 140 of the mounting assembly 130. The mounting assembly 130, in turn, is secured to the base support 150 by any means of fastening. FIGS. 1 and 2 depict the use of a strip of aviation-grade velcro 164 to secure the mounting assembly 130 to the base support 150.

Although the demands of securing a patient to a stretcher necessitate an ostensibly horizontal configuration to the modular payload system, this example should not be construed to limit the potential geometries of configuration. For example, similar modular configurations could be employed in vertical fashion for the secured storage of cargo or instrumentation. Described below are some possible components and configurations of a modular payload system.

### Base Supports

Base supports may comprise any means of supporting a payload without directly coupling to the payload. The term “base support” should not be construed to limit proper base supports to objects that exist at the bottom of a modular system, but rather base supports may comprise any modular components to which all other components are ultimately attached. In some embodiments, the base support may be a fixed object such as a rack, frame, holder, mount, cradle, bracket, or plate. A fixed base support may be fastened in a horizontal, vertical, sideways, inverted, diagonal, or skewed position relative to the area in which it is contained. For example, a base support may be ceiling mounted, allowing payloads to be secured above a working space in the cargo bay of an aircraft. A fixed base support may be fastened by any suitable means, including adhesives, screws, bolts, rivets, welds, snaps, and velcro. In other embodiments, the base support may be a mobile object such as a cart, trailer, boom, or a dolly. A mobile base support may also be fastened in a horizontal, vertical, sideways, inverted, diagonal, or skewed position relative to the area in which it is contained.

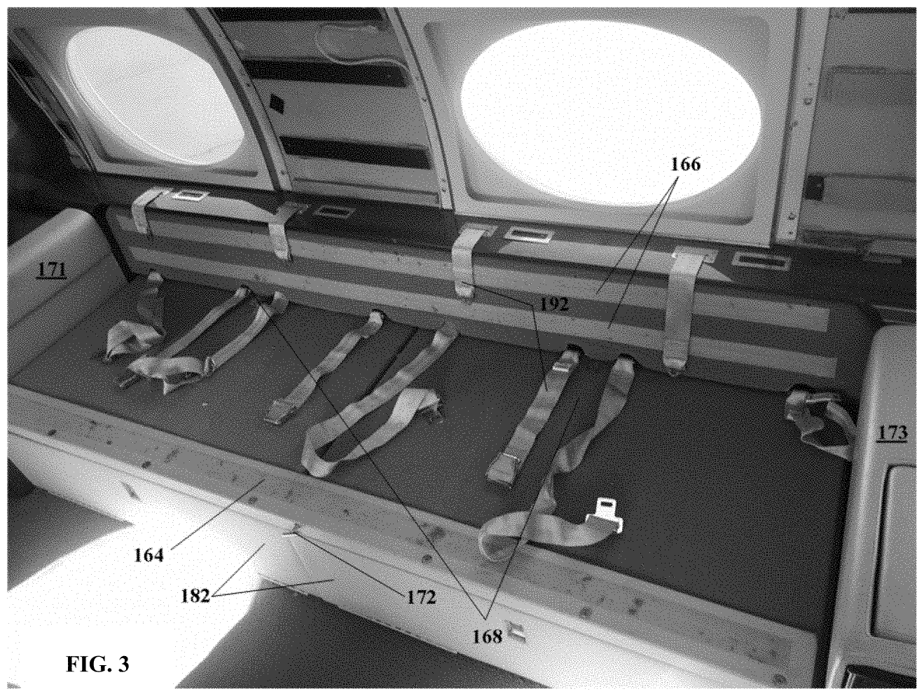

FIGS. 1 and 2 illustrate an exploded view of a modular medical stretcher system 100 with a base support 150 constructed from the body of a bench seat as would be found on a private aircraft. As shown, couch cushions could be removed from the substantially horizontal top surface 160 of the base support 150 to provide a surface area to mount the stretcher system. FIG. 3 shows an image of a base support fashioned from the body of a bench seat on a private jet airplane. The base support of FIG. 3 has been adapted to accommodate a modular stretcher system for the airborne evacuation of medical passengers. The base support is bounded by a foot-side bench seat arm 171, a head-side bench seat arm 173, and a right-hand side wall 175. A strip of aviation-grade velcro 164 traverses the length of the horizontal top surface 160 of the base support 150 shown in FIG. 3. As well, two strips of aviation-grade velcro 166 along the right-hand side wall 175 are shown in FIG. 3. The aviation grade velcro may serve the dual purpose of securing cushions when the base support is configured as a bench seat and attachment points for the mounting assembly 130 and other payload system components when configured to secure a payload.

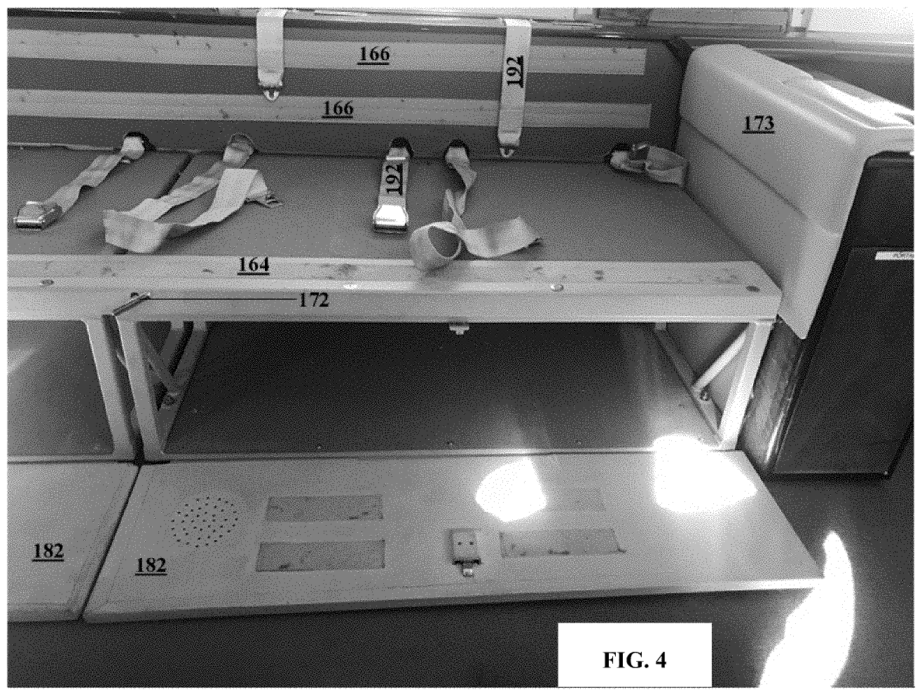

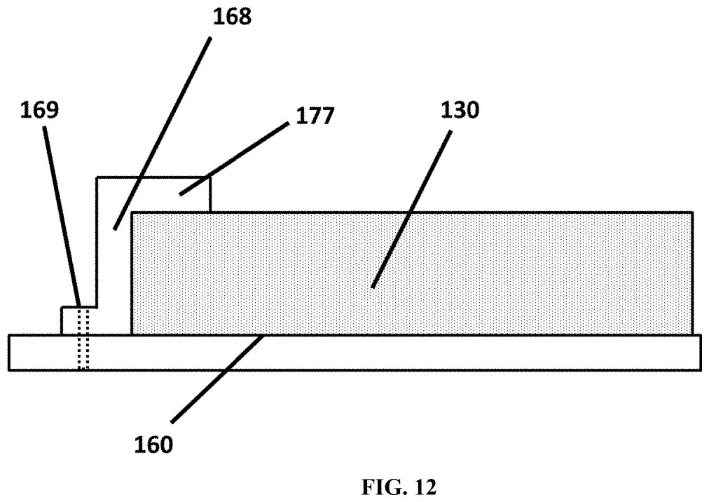

The base support 150 may comprise additional components. The convertible bench seat of FIG. 3 depicts two mounting assembly guide inserts 168 that serve to guide the installation of the mounting assembly 130 and provide stability and constraint after the assembly has been placed. FIG. 12 depicts a cross-sectional view (not to scale) of a mounting assembly guide insert 168 secured to the horizontal top surface 160 by some means of fastening 169, such as a screw or bolt. The guide insert upper finger 177 provides a guide that limits the ability of the mounting assembly 130 to slide any further toward the side wall 175 and provides stabilization against vertical motion by the mounting assembly 130. FIG. 3 also shows the bench seat straps and buckles 192 which may provide additional points of connection for a payload system. Also, FIG. 3 shows a base support extension handle 172 that provides a means for extending or translating the payload support system outward from the right-hand side of the air vehicle. In other embodiments, such extensional capability could be provided by other means such as sliding tracks or electromechanical actuation. FIGS. 3 and 4 provide additional detailed views of the base support 150 for an air vehicle bench seat. Base support compartment covers 182 provide access to the volume within the body of the base support 150.

The base support 150 may also provide additional utility via the utilization of available volume within the body of the base support 150. The base support 150 depicted in FIGS. 1 and 2 may comprise one or more compartments 180 for utility access or storage. The compartments 180 may be capable of extension outward for access and retraction into a recessed configuration for stowage. The compartments 180 may be connected to the base support 150 via tracks, slide bearing, hydraulics or any other means of providing translational movement into and out of the base support 150. The means of articulation for the base support compartments 180 may be attached to any portion of the base support structure, including frames, flooring or the underside of the horizontal base support surface 160. The base support compartments 180 may have some finite volume 184 within which to store or emplace equipment or other devices. The base support may offer a utilizable internal volume of about 0.1 ft³, 0.5 ft³, 1 ft³, 2 ft³, 3 ft³, 4 ft³, 5 ft³, 6 ft³, 7 ft³, 8 ft³, 9 ft³, 10 ft³, 15 ft³, or 20 ft³ or more.

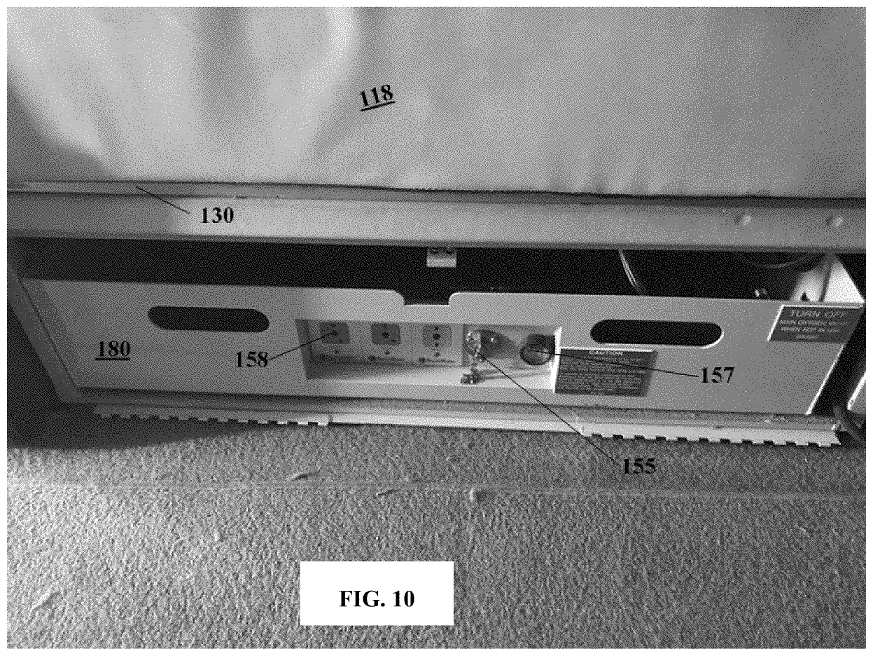

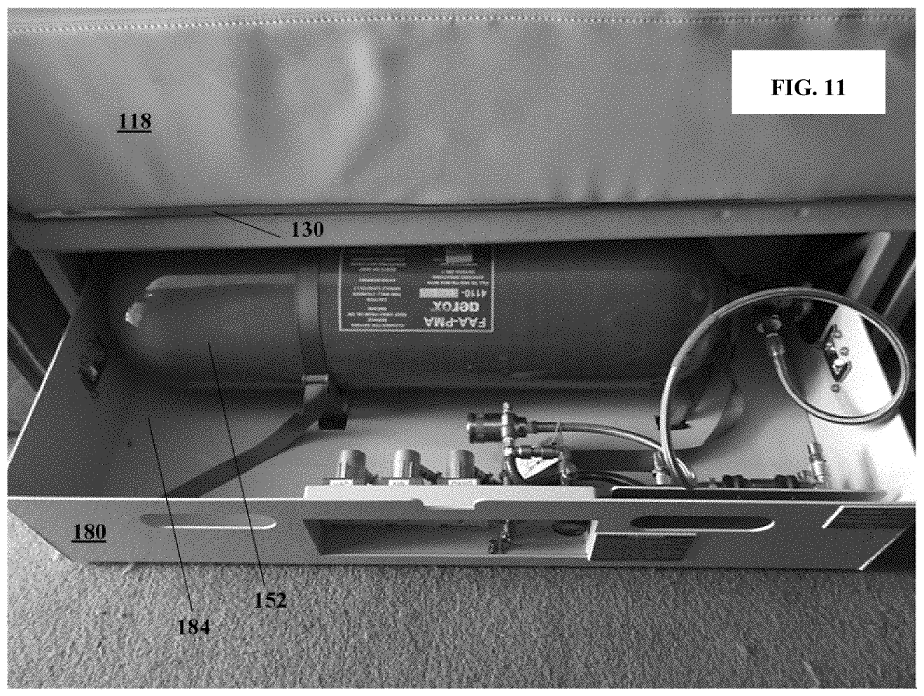

FIGS. 1 and 2 provide an exemplary depiction of how the base support compartments 180 may be utilized. For medical applications, the base support compartment volume 184 may hold a variety of medical utilities such as compressed gas cylinders 152 connected to utility ports 156 and 158. The compressed gases, such as air, oxygen, nitrogen, and carbon dioxide, may be controlled via a mounted regulator 155 and pressure gauge 157. The base support compartments 180 may hold suction lines through utility ports 156 provided by a vacuum pump 162. FIG. 10 depicts a stowed utility base support compartment 180 in the base support of an air vehicle bench seat. FIG. 11 depicts the same compartment drawn forward to show the internal utilization of the compartment volume 184. The base support may also comprise a variety of electrical ports and outlets 154 that provide power into the base support and provide connections for electrical devices external to the payload system (e.g. heart rate and blood pressure monitors). Electricity may be supplied to the base support 150 as direct current (DC) e.g. batteries, or alternating current (AC). In some embodiments, an electrical source may be housed within the internal volume 184 of the base support. In other embodiments, the electrical source may be external to the base support. DC power sources may supply electrical energy at various voltages including 1.5V, 9V, 12V, 24V, or 28V. AC power sources may supply electrical energy at various voltages including, but not limited to 110V, 120V, 208V, 220V, 230V, or 240V. AC power sources may be one-phase or three-phase. AC power sources may have a frequency of 50 Hz or 60 Hz. Electricity may be supplied to the base support at various amperages. In some embodiments, the base support may be supplied up to 0.1 A, up to 0.5 A, up to 1 A, up to 5 A, up to 10 A, up to 15 A, up to 20 A, up to 25 A, up to 30 A, up to 35 A, up to 40 A, up to 45 A, up to 50 A, up to 55 A, up to 60 A, up to 65 A, up to 70 A, up to 75 A, up to 80 A, up to 85 A, up to 90 A, up to 95 A, up to 100 A, up to 110 A, up to 120 A, up to 130 A, up to 140 A, up to 150 A, up to 160 A, up to 170 A, up to 180 A, up to 190 A, or up to 200 A. Electrical connectivity to the base support may comprise other components including outlets, wires, switches, plugs, couplings, indicator lights, fuses, resistors, capacitors, and ground connectors.

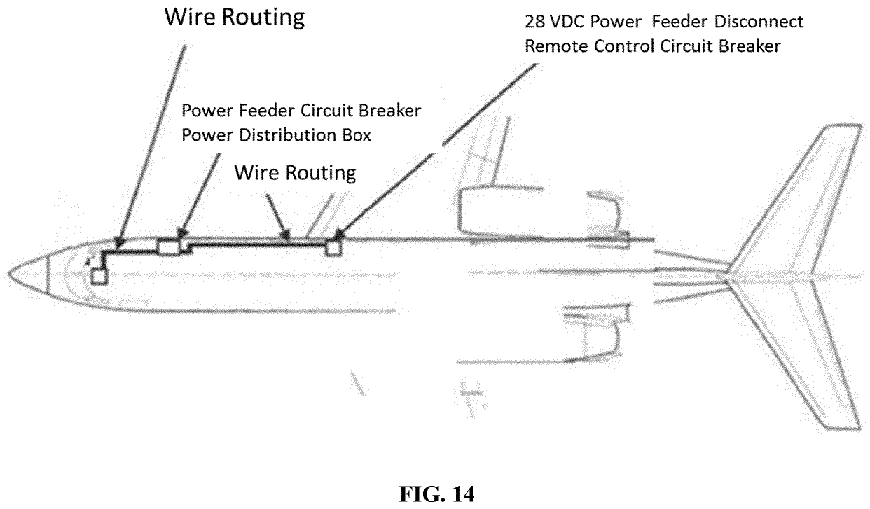

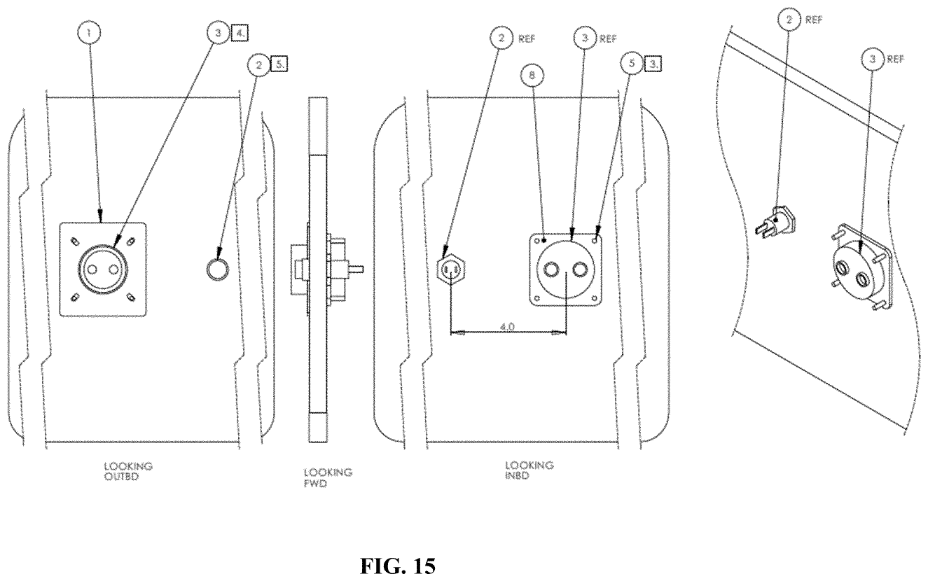

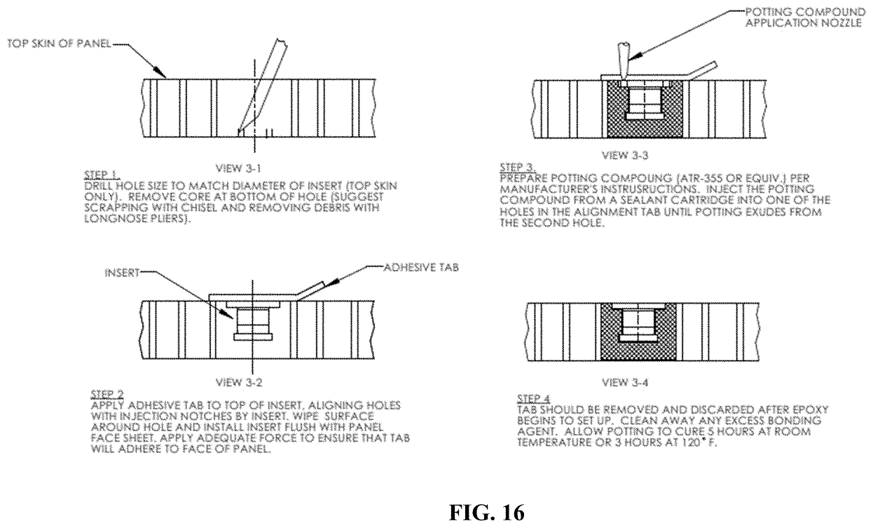

In one particular embodiment, electrical power may be supplied to the base support of an aircraft bench seat. The base support may be connected to the main power box of the aircraft by a cable that is run along the fuselage. FIG. 14 shows a conceptual diagram of the routing of electrical wiring between an aircraft power box and a payload transport system. Electrical power at up to 50 A at 28V DC may be supplied to the base support. The electrical power may enter in to the base support by an outlet comprising a cylindrical connector. The described electrical configuration and other configurations may be compliant with the requirements of Federal regulatory agencies, including the Federal Aviation Administration (FAA). In some embodiments, the electrical configuration may qualify for an FAA Supplemental Type Certificate (STC) or an equivalent designation from another regulatory agency. A supplemental type certificate (STC) is a type certificate (TC) issued when an applicant has received FAA approval to modify an aeronautical product from its original design. The STC, which incorporates by reference the related TC, approves not only the modification but also how that modification affects the original design. FIG. 15 shows a conceptual diagram of an electrical connector for a base support of an aircraft bench seat. The cylindrical connector 3 may be attached to the base support using a mounting bracket 8 that is secured with epoxy 6. FIG. 16 depicts the installation of an electrical connector using epoxy via four-step process. In the first step View 3-1, a cut out is created in the base support. In the second step View 3-2, the cylindrical connector is place in the cut out. In the third step View 3-3, free space between the cylindrical connector and the cut out is filled with an aviation-grade epoxy. In the fourth step View 3-4, excess epoxy is removed and cured, securing the electrical connector the base support. As shown in FIG. 15, the base support electrical system may also comprise an LED indicator light 2 that is operatively connected to the incoming power source.

The base support 150 may comprise various materials of construction. The base support may comprise a metal frame. The metal frame may be constructed from various metals, including steel and aluminum. The base support may comprise other materials, such as wood, particle board, composites, laminates, and polymers. A base support may comprise insulating materials to thermally isolate the base support compartment volume 184 from the surrounding system for applications where the temperature may differ from the ambient temperature, e.g. heat generation from a pump 162 or a refrigeration system within a base support compartment 180. Insulating materials may include vacuum insulated paneling, silica aerogels, polyurethane rigid paneling, foil-faced polyurethane paneling, polyisocyanurate rigid paneling, polyisocyanurate spray foam, polyurethane spray foam, phenolic spray foam, polystyrene paneling, fiberglass batting, cardboard, cellulose loose-fil, polyethylene foam, perlite loose fill, vermiculite, and refractory materials. Base supports for biomedical applications may comprise antimicrobial materials, e.g. silver nanoparticles. Materials chosen for the construction of base supports may be chosen for other purposes including anti-static, stain resistance, chemical resistance, hardness, toughness, electrical properties, magnetic properties, acoustic properties, machinability, formability, durability, and cost.

The base support 150 may be constructed to provide stable structural support to a broad range of payloads. The base support may provide a means of providing compressional and extensional strength as well as torsional rigidity to the payload structure, depending upon the configuration of the system. The base support may have a rated payload capacity of up to about 100 lbs, about 150 lbs, about 200 lbs, about 250 lbs, about 300 lbs, about 350 lbs, about 400 lbs, about 450 lbs, about 500 lbs, about 600 lbs, about 700 lbs, about 800 lbs, about 900 lbs, about 1000 lbs, about 1200 lbs, about 1400 lbs, about 1600 lbs, about 1800 lbs, about 2000 lbs, or about 4000 lbs. The base support may be optionally reinforced for increased strength, stability or rigidity for particular applications as necessary. Reinforcement may be provided by the addition of struts, beams, brackets, sheets, or any other means for providing the reinforcement.

The base support 150 may be fixed to a footprint within a chosen environment. For example, the base support shown in FIGS. 1 and 2 may connected to the cabin floor surface of the air vehicle. Base supports may be fixed by any applicable means including the use of screws or bolts, rivets, fasteners, anchors, latches, pins, cables, ropes, chains, or hooks. The base support may be mobile. Mobility may be provided by wheels, casters, tracks, pulleys, booms, or any other means of providing conveyance of motion to the base support.

### Mounting Assemblies

The mounting assembly may comprise a section of the modular payload system that serves as a coupling between the base support and the payload mounting system. The mounting system creates flexibility in the payload system by offering a universal connection system that secures and stabilizes the payload mounting system while offering a range of options for securing the payload to the base support. In some embodiments, the mounting assembly may provide other utility to the payload system such as offering vibrational dampening, increased strength, increased lateral rigidity, increased longitudinal rigidity, increased torsional rigidity, increased footprint, or decreased footprint. A mounting assembly may comprise one or more pieces that attach to the base support. In some embodiments, the mounting assembly may comprise one, two, three, four, five, six, seven, eight, nine, ten, eleven, twelve, thirteen, fourteen, fifteen, sixteen, seventeen, eighteen, nineteen, or twenty pieces. Mounting assemblies piece may be arranged to touch, join, mate, overlap, or otherwise be in contact with neighboring mounting assembly pieces. In some embodiments, mounting assembly pieces may not physically contact other mounting assembly pieces.

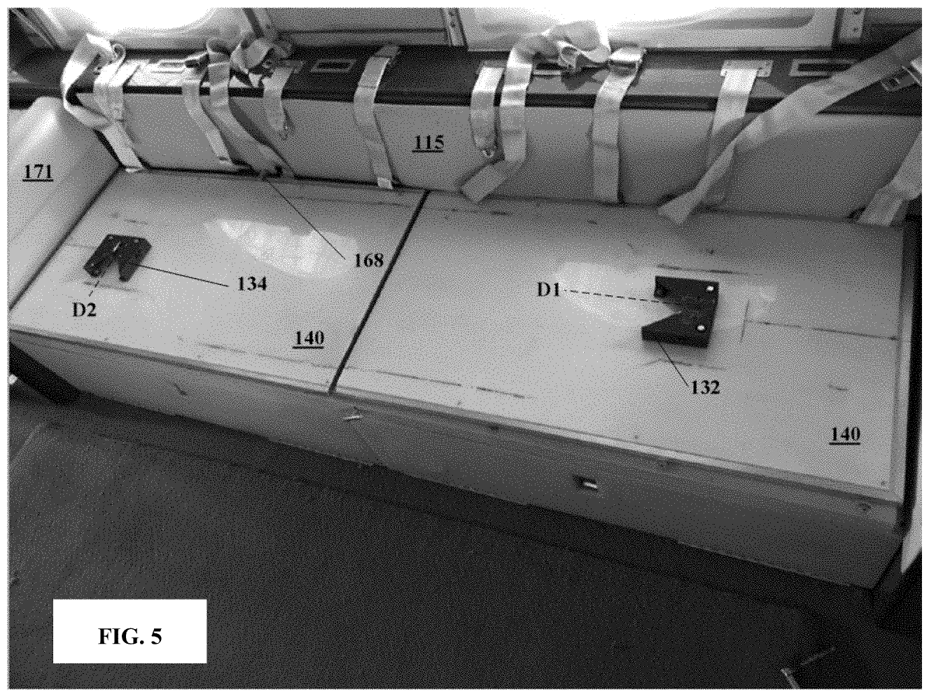

A mounting assembly may comprise at least two components: i) an assembly platform, and ii) a payload attachment mechanism. FIGS. 1 and 2 show an exploded view of an example payload system 100 for a private aircraft where the mounting assembly 130 comprises a substantially horizontal sheet with two keyhole locking mechanisms 132 and 134. In this embodiment, the mounting assembly is intended to occupy roughly the same footprint as the horizontal top surface 160 of the base support 150. FIG. 5 shows a photograph of a representative mounting assembly 140 secured to the base support. The mounting assembly 140 is inserted into place laterally in a horizontal fashion with bench seat arms 171 and 173 (not shown) forming end barriers to constrain the length-wise movement of the mounting assembly. The two pieces of the mounting assembly are constrained from rightward lateral motion by the mounting assembly guide inserts 168. The left-hand side of the mounting assembly may be secured to the base support velcro strip 164 by a mating strip of aviation-grade velcro (not shown) on the underside of the horizontal surface of the mounting assembly 140. The mounting assembly may optionally contain a sideboard 115. In the convertible aviation bench seat example, the sideboard may mount via aviation-grade velcro strips (not shown) that mate to the right-hand side velcro strips 166. The sideboard may serve multiple purposes, including providing chemical or biological containment, constraining the area of the mounting assembly, providing lateral stability to the payload mounting support, providing additional points of attachments, or providing additional straps or other implements for securing payloads.

A mounting assembly may comprise various mechanisms for securely attaching a payload to the mounting assembly. An attachment mechanism may mate with a post, pin, hook, latch, or any other implement that is secured to a payload mounting platform. An attachment mechanism may comprise a locking mechanism that prevents unintended release of a payload. Attachment mechanisms may function in a lock and key style where the insert portion of the payload mounting platform must be rotated in a certain direction to free it from the attachment mechanism. An attachment mechanism may actively grip an insert portion of a payload mounting platform, e.g. a spring-loaded jaw mechanism. An attachment mechanism may be a manually-installed fastener such as a nut and bolt to secure a payload mounting platform. An attachment mechanism may comprise a magnetic coupling that can only be released by the application of sufficient separating force. A magnetic coupling may comprise a permanent magnet or an electromagnet. An attachment mechanism may be actuated manually or electronically. An attachment mechanism may comprise a quick-release mechanism. A quick release mechanism may comprise a handle, level, crank, or other mechanism that physically controls the opening and closing of the attachment mechanism. Attachment mechanisms may be reconfigurable to allow a single mounting assembly to be used for multiple purposes. Attachment mechanisms may be detachable or placed on moveable inserts in the mounting assembly to allow simple reconfiguration.

In the exemplary illustrations of FIGS. 1, 2 and 5, the attachment mechanisms are keyhole locking mechanisms 132 and 134. The keyhole locking mechanisms 132 and 134 both feature a fixed open jaw design that serves to guide an insert portion of a mounting platform into the locking mechanism from a wide variety of angles and approaches. Once an insert portion has entered the locking portion of the keyhole locking mechanism, the payload mounting platform is secured at that attachment point. Examples of configurations of attachment mechanisms for a variety of applications are discussed in more detail below.

The mounting assembly 130 may comprise various materials of construction. The mounting assembly may comprise a metal frame. The metal frame may be constructed from various metals, including steel and aluminum. The mounting assembly may comprise other materials, such as wood, particle board, composites, laminates, and polymers. The chosen materials may be sandwiched sheets of various materials. The mounting assembly may comprise sheet metals for increase rigidity or strength. Chosen sheet metals may include steel, stainless steel, and aluminum. Mounting assemblies may comprise polymer sheets. Chosen polymers may include high-density polyethylene, low-density polyethylene, polypropylene, polystyrene, acrylics, nylons, polycarbonates, or any other suitable polymer. A mounting assembly may comprise insulating materials to thermally isolate the mounting assembly 130 from the surrounding system for applications where the temperature may differ from the ambient temperature, e.g. heat generation from a pump 162 or a refrigeration system within a base support compartment 180. Insulating materials may include vacuum insulated paneling, silica aerogels, polyurethane rigid paneling, foil-faced polyurethane paneling, polyisocyanurate rigid paneling, polyisocyanurate spray foam, polyurethane spray foam, phenolic spray foam, polystyrene paneling, fiberglass batting, cardboard, cellulose loose-fill, polyethylene foam, perlite loose fill, vermiculite, and refractory materials. A mounting assembly may comprise a material for shock-dampening properties. A shock-dampening material may consist of cellular materials, rubbers, or foams. Mounting assemblies for biomedical applications may comprise antimicrobial materials, e.g. silver nanoparticles. Materials chosen for the construction of mounting assemblies may be chosen for other purposes including anti-static, stain resistance, chemical resistance, hardness, toughness, electrical properties, magnetic properties, acoustic properties, machinability, formability, durability, and cost.

A mounting assembly may be physically secured to a base support in a modular payload system. The mounting assembly may be fixed in a permanent or semi-permanent fashion to a base support. The mounting assembly may be fastened by means such as screws, bolts, pins, rods, locks, or hooks to corresponding receptacles on the base support. The mounting assembly may be permanently fixed via adhesives such as glues, epoxies, thermosetting adhesives, cements, resins, and contact adhesives. The mounting assembly may be fastened by non-permanent means such as magnetic couplings, releasable latches, releasable buckles, hooks, snaps, or velcro.

In the exemplary bench seat application depicted in FIGS. 1, 2, 3, and 4, aviation-grade velcro 164 is used as a means to partially secure the mounting assembly 130 to the base support 150. The aviation-grade velcro may be secured to the bottom surface of the mounting assembly by an adhesive backing. The mounting assembly 130 is further secured by a mounting assembly guide insert 168.

The mounting assembly 130 may be constructed to provide stable structural support to a broad range of payloads. The mounting assembly may provide a means of providing compressional and extensional strength as well as torsional rigidity to the payload structure, depending upon the configuration of the system. The mounting assembly may have a rated payload capacity of up to about 100 lbs, about 150 lbs, about 200 lbs, about 250 lbs, about 300 lbs, about 350 lbs, about 400 lbs, about 450 lbs, about 500 lbs, about 600 lbs, about 700 lbs, about 800 lbs, about 900 lbs, about 1000 lbs, about 1200 lbs, about 1400 lbs, about 1600 lbs, about 1800 lbs, about 2000 lbs, or about 4000 lbs. The mounting assembly may be optionally reinforced for increased strength, stability or rigidity for particular applications as necessary. Reinforcement may be provided by the addition of struts, beams, brackets, sheets, or any other means for providing the reinforcement.

### Payload Mounting Platforms

The payload mounting platform may comprise a component of a modular payload system that accommodates a payload and securely attaches to the mounting assembly. In some embodiments, the payload mounting platform may comprise one or more pieces that physically contact the payload. In other embodiments, the payload itself may be adapted into a payload mounting platform. A payload mounting platform may comprise any device or system that has the characteristics of i) physically accommodating a payload, and ii) having the necessary hardware to connect to the attachment mechanism of the mounting assembly. A payload may comprise any transportable object, whether living, non-living, or inanimate. A payload may comprise a living organism, including humans, pets, domesticated animals, non-domesticated animals, and plants. A payload may comprise non-living or inanimate objects such as foodstuffs, clothing, consumer goods, biological samples, computers, scientific equipment, firearms, munitions, chemicals, gases, batteries, communications equipment, luggage, clothing, currency, tools, furniture, transportation equipment, mechanical equipment, electrical equipment, safety equipment, or transportable waste.

A payload mounting platform may be capable of physically accommodating a payload. The payload may physically contact the payload mounting platform via the use of a means of fastening, such as straps, buckles, clamps, hooks, ropes, chains, cords, or couplings. A payload may physically contact the payload by a means of physical containment such as drawers, cabinets, doors, bars, cages, kennels, buckets, baskets, netting, fencing, bags, pouches, boxes, bins, safes, lockers, or racks. A payload may be permanently or semi-permanently affixed to the payload mounting platform, e.g. scientific equipment mounted in transportable cabinetry. A payload may comprise a means for storage, e.g. a refrigeration system for transporting food or medical supplies. A payload may comprise a system that converts a system into another system, e.g. an airplane bench seat that converts via a modular payload system into a desk or workspace.

A payload mounting platform may comprise hardware to connect to the attachment mechanism of a mounting assembly. The necessary hardware may depend upon the particular attachment mechanism of a mounting assembly. The connection hardware on the payload mounting platform may comprise a piece that mates with a corresponding piece on the mounting assembly. The connection between the connecting hardware of the payload mounting platform and the attachment mechanism of the mounting assembly may be free or comprise a means of locking or retention. A free connection may comprise any means of attachment that does not retain the connecting hardware, for example a post that is inserted or removed through a curving channel or slot. A retained connection may include any method that physically secures the connecting hardware until the connection is released, such as gates, latches, jaws, clamps, or couplings. In some embodiments, the retention mechanism may be a keyhole locking mechanism, a quick-release mechanism, or a threaded coupling. A retention mechanism may be manually secured or released. A retention mechanism may be electronically controlled. The connection hardware may comprise posts, pins, brackets, magnets, loops, grommets, hooks, couplings, or fittings. Connection hardware may have a particular shape or aspect, such as cylindrical, square, hexagonal or star-shaped. The connection hardware may be cylindrical with a flat face such that the flat face is gripped by a locking mechanism.

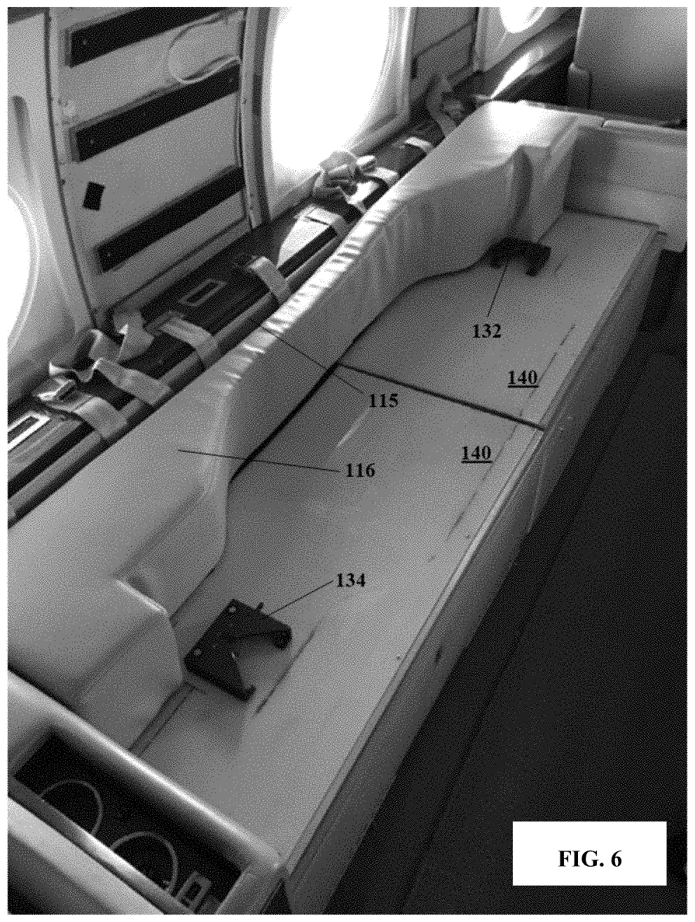

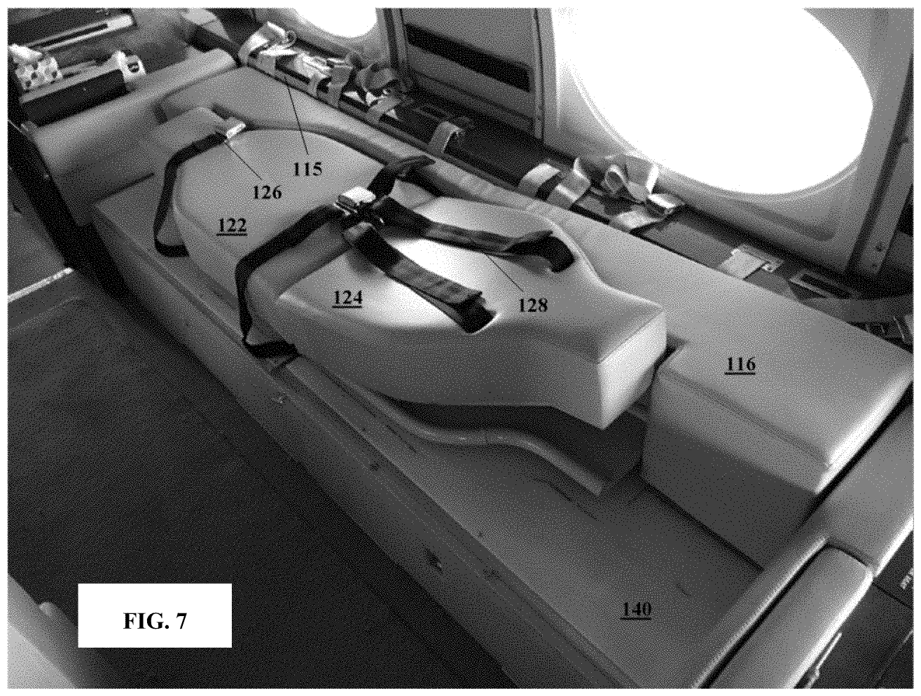

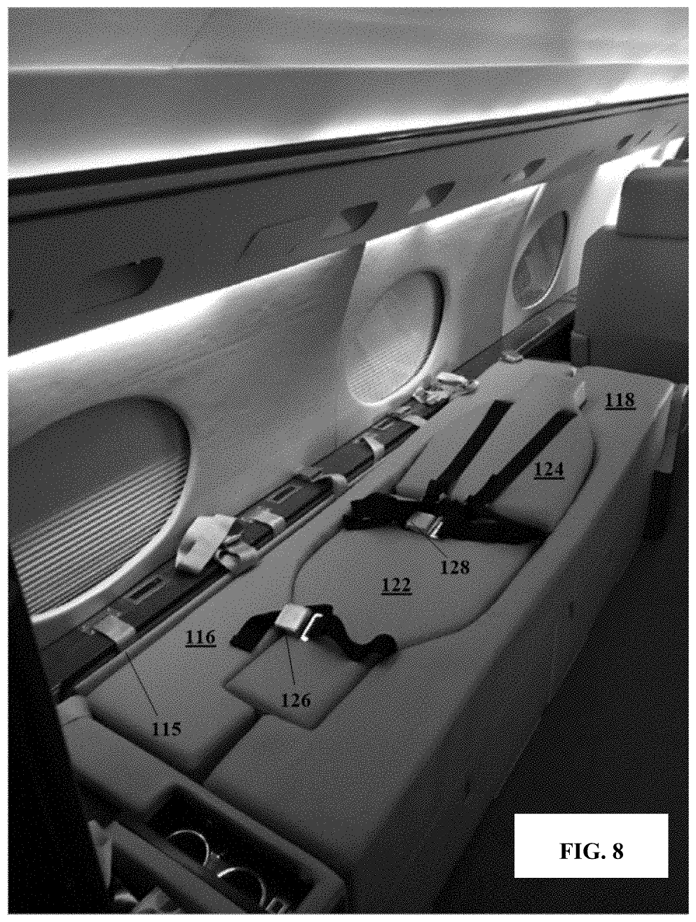

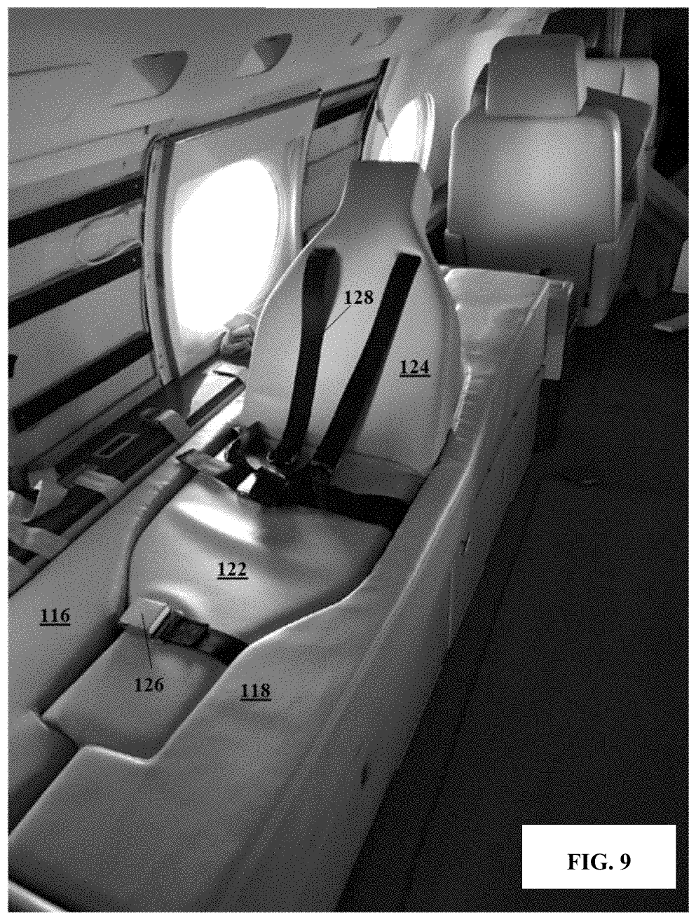

An example of a payload mounting platform for the support of a portable stretcher can be seen in FIGS. 1 and 2. The payload mounting platform 110 may be secured to the mounting assembly 130 by one or more insert posts 112 that comprise connection hardware for this particular system. The insert posts 112 can be secured into the insert keyhole locking mechanisms 132 and 134. In a locked position, the payload mounting platform may be fully secured to the mounting assembly. The payload mounting platform 110 may feature other features for enhanced utility. The payload mounting platform 110 shown in FIGS. 1 and 2 feature a central utility port 113 and side utility ports 111. These ports may be used for various purposes such as anchor points for payload attachments and installment points for additional features such as mechanical devices like hydraulics or electronic devices. The payload mounting platform 110 may also feature payload supporting members 114. The supporting members 114 may be used to increase the strength of the payload mounting platform, or increase lateral, longitudinal, or torsional rigidity of the platform. The mobile stretcher system depicted in FIGS. 1 and 2 necessitates a horizontal orientation, so the payload mounting system 110 has a planar, substantially horizontal top surface 120 to which cushioning can be affixed. FIGS. 6 and 7 depict the placement of a mobile stretcher system by the conversion of a bench seat on a private aircraft. FIG. 6 shows the mounting assembly 130 installed on the base support 150. A sideboard 115 has been installed along the patient's right-hand side and a right-hand cushion 116 has been placed in preparation for the stretcher to be installed. FIG. 7 shows a mobile stretcher installed on the mounting assembly 130. The payload mounting platform 110 has been inserted into the insert keyhole locking mechanisms 132 and 134 by insert posts 112. Affixed to the payload mounting platform 110 are two cushions, a stretcher leg cushion 122 and a stretcher torso cushion 124. The mobile stretcher also features two payload fastening mechanisms: a stretcher leg restraint 126 and a stretcher chest harness 128 for securing a patient during flight. A fully-assembled modular payload system can be seen in FIGS. 8 and 9. A left-hand side cushion 118 has been installed to create a wider bed surface for a patient. Utilization of the base support extension handle 172 allows the entire system to be spaced even farther from the cabin wall, creating increased space for a patient. FIG. 8 depicts the stretcher in a fully reclined position, while FIG. 9 shows an upright configuration of the stretcher, achieved by a mechanical support (not shown) attached to the payload mounting platform 110.

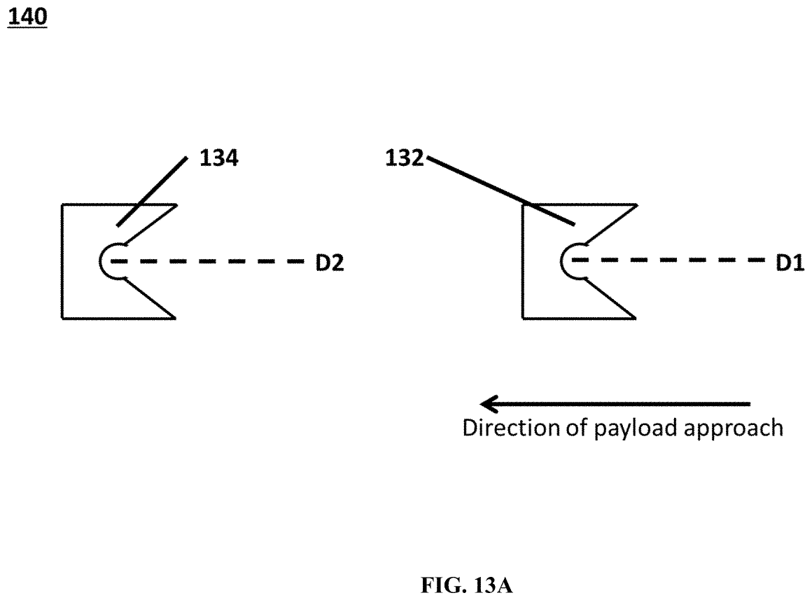

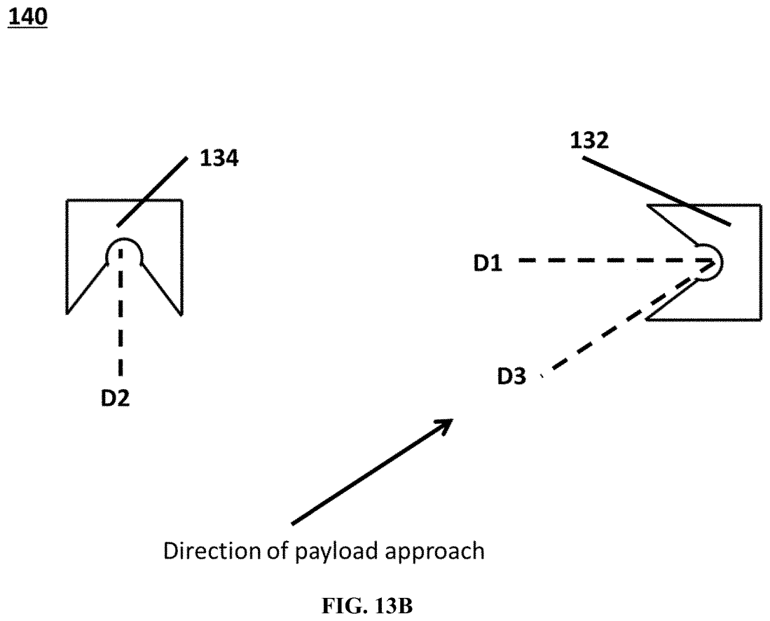

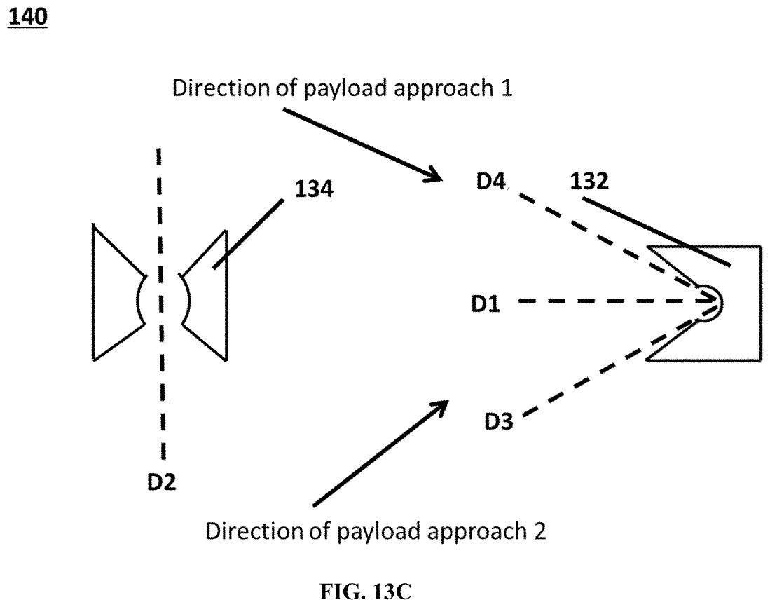

The selection of attachment mechanisms and their location on the mounting assembly may vary based upon the chosen application. FIGS. 13A, 13B, and 13C depict different configurations of a keyhole locking mechanism for the installment of a payload mounting platform in a transverse position relative to the horizontal top surface 140 of the mounting assembly. FIG. 13A depicts a longitudinal approach of a payload mounting platform, as might be used when the lengths of the system are inaccessible but at least one width is accessible. The keyhole locking mechanisms 132 and 134 are positioned to accept insert posts along longitudinal axes D1 and D2, which share the same orientation. A payload mounting platform would be directed into position from the right-hand side of the mounting assembly with its centerline running along the same axis as D1 and D2. When the insert posts contacted the keyhole locking mechanisms 132 and 134, the payload would be secured. FIG. 13B depicts a lateral approach of a payload mounting platform as might be used when only on length of the payload system is accessible. In FIG. 13B, the keyhole locking mechanisms are oriented at 90° relative to each other such that axes D1 and D2 are orthogonal. To install a payload in a transverse position (substantially parallel to axis D1) in this configuration, the payload would be brought in at an angle such that the orientation fell within the bounds defined by axes D1 and D3. When the first insert post contacted the keyhole locking mechanism 132, the payload would then be rotated in a clockwise fashion until the second insert post contacted the second keyhole locking mechanism 134 along an axis substantially co-linear with axis D2. When the insert post entered the keyhole locking mechanism 134, the payload would be secured. FIG. 13C depicts a similar situation to FIG. 13B, except FIG. 13C is configured to accept a payload from either lateral position using a keyhole locking mechanism 134 that could accept an insert post from either side along axis D2. The example attachment configurations depicted in FIGS. 13A, 13B, and 13C only represent three possible configurations of a particular type of attachment mechanism. The present disclosure anticipates numerous possible configurations of attachment systems and methods for mounting with such systems.

The payload mounting platform 130 may comprise various materials of construction. Material choice will be guided in large measure by the applications, e.g. carrying a medical patient vs. carrying computer equipment. The payload mounting platform may comprise a metal frame. The metal frame may be constructed from various metals, including steel and aluminum. The payload mounting platform may comprise other materials, such as wood, particle board, composites, laminates, and polymers. The chosen materials may be sandwiched sheets of various materials. The payload mounting platform may comprise sheet metals for increase rigidity or strength. Chosen sheet metals may include steel, stainless steel, and aluminum. Payload mounting platforms may comprise polymer sheets. Chosen polymers may include high-density polyethylene, low-density polyethylene, polypropylene, polystyrene, acrylics, nylons, polycarbonates, or any other suitable polymer. A mounting assembly may comprise insulating materials to thermally isolate the payload mounting platform from the surrounding system for applications where the temperature may differ from the ambient temperature, e.g. heat generation from a pump 162 or a refrigeration system within a base support compartment 180. Insulating materials may include vacuum insulated paneling, silica aerogels, polyurethane rigid paneling, foil-faced polyurethane paneling, polyisocyanurate rigid paneling, polyisocyanurate spray foam, polyurethane spray foam, phenolic spray foam, polystyrene paneling, fiberglass batting, cardboard, cellulose loose-fill, polyethylene foam, perlite loose fill, vermiculite, and refractory materials. A payload mounting platform may comprise a material for shocking dampening properties. A shock dampening material may consist of cellular materials, rubbers, or foams. Payload mounting platforms for biomedical applications may comprise antimicrobial materials, e.g. silver nanoparticles. Materials chosen for the construction of payload mounting platforms may be chosen for other purposes including anti-static, stain resistance, chemical resistance, hardness, toughness, electrical properties, magnetic properties, acoustic properties, machinability, formability, durability, and cost.

The payload mounting platform 110 may be constructed to provide stable structural support to a broad range of payloads. The payload mounting platform may provide a means of providing compressional and extensional strength as well as torsional rigidity to the payload structure, depending upon the configuration of the system. The payload mounting platform may have a rated payload capacity of up to about 100 lbs, about 150 lbs, about 200 lbs, about 250 lbs, about 300 lbs, about 350 lbs, about 400 lbs, about 450 lbs, about 500 lbs, about 600 lbs, about 700 lbs, about 800 lbs, about 900 lbs, about 1000 lbs, about 1200 lbs, about 1400 lbs, about 1600 lbs, about 1800 lbs, about 2000 lbs, or about 4000 lbs. The payload mounting platform may be optionally reinforced for increased strength, stability or rigidity for particular applications as necessary. Reinforcement may be provided by the addition of struts, beams, brackets, sheets, or any other means for providing the reinforcement.

### EXAMPLES

### Example 1

### Ambulance Stretcher System

A modular payload system may be utilized to secure a stretcher in the rear compartment of an ambulance. The ambulance may be outfitted with a base support comprising either a removable wheeled gurney or a fixed base stand. The fixed based stand may have utility compartments for the storage of medical supplies and utility ports for the supply of compressed gases, suction, or electricity for instruments and monitors. The base support will have a substantially horizontal top surface with velcro strips oriented longitudinally along the top surface. The top surface will also have two sets of cylindrical metal pins arranged in square patterns affixed to and extending upward. The pins define the placement of the mounting assembly pieces.

A two-piece mounting assembly will be installed atop the base support. The mounting assemblies will be constructed from a sandwiched composite of wood, rubber and aluminum sheeting. At each corner of the square mounting assembly pieces are metal grommets extending through the depth of the mounting assembly pieces. Affixed to the substantially horizontal top surface of the mounting assembly is a keyhole locking mechanism with a triangular open jaw design. The locking mechanisms are affixed to the mounting assemblies with machine screws. The undersides of the mounting assemblies have strips of velcro affixed with an adhesive backing. The mounting assemblies are installed by positioning them such that the grommets slide over the upward-oriented pins. The mounting assemblies are further secured by the mating of the velcro on the contacting surfaces. The mounting assemblies are positioned such that the jaws of the keyhole locking mechanisms both face toward the rear doors of the ambulance. The keyhole locking mechanisms are operatively connected to handles that open a spring-loaded jaw in the locking mechanism when the handle is pulled.

The stretcher consists of a payload mounting platform, cushioning, straps, and a recliner adjustment mechanism. The payload mounting platform is constructed of an external, hollow-tubing aluminum frame with a high-density polyethylene skin between the frame rails. The aluminum frame is narrowest at the feet and head and wider through the torso region. The polyethylene skin has three small, rectangular cut-outs along each side of the aluminum frame, and one large central cut-out located beneath the torso area of the stretcher. Thick cushioning is affixed to the aluminum frame by rivets through the polyethylene skin. The cushioning is constructed of a foam padding covered by a stain-resistant, antimicrobial nylon skin and has a thin aluminum backing on the underside. Anchored to the small rectangular cut-outs are woven polyester straps that are connected to the frame by rivets driven through the aluminum. The two straps on the foot end of the stretcher end with a mating buckle and latch. The four straps in the torso region of the stretcher form a chest harness. The central port in the polyethylene skin houses a hydraulic shock that anchors to the central utility port of the payload mounting platform and the aluminum backing of the torso portion of the cushioning. The hydraulic shock is operatively connected to a handle near the head of the stretcher that adjusts the degree of recline of the stretcher. The foot and head end of the stretcher have cylindrical insert posts made of aluminum welded to the payload mounting platform frame.

The stretcher is brought in to the rear compartment of the ambulance through the rear doors, head side first. The stretcher is initially lifted above the mounting assemblies until the head side insert post is between the two keyhole locking mechanisms and the stretcher is aligned along the longitudinal axis of the payload system. The stretcher is lowered and slid toward the fore of the rear ambulance cabin until the insert posts push open the jaws of the keyhole locking mechanisms. Once the stretcher is pushed far enough forward, the jaws close, securing the stretcher to the payload system. The stretcher can be released by pulling the handles of the locking mechanisms until the jaws open and the insert posts are released.

### Example 2

### Transfer Gurney System

A wheeled gurney may be used as a base support for the modular payload system. The gurney may comprise any wheeled cart system such as a simple metal frame cart or a more complex, electronically-controlled hydraulic system. The substantially horizontal top surface of the gurney cart will be modified to include upward-facing, cylindrical metal posts that mate with the grommets of the mounting assembly. The rest of the modular system is the same as described in Example 1.

The mounting assemblies may be configured variously on the gurney cart. The keyhole locking mechanisms can be oriented in the same direction for a head-on payload emplacement as in Example 1. One of the keyhole locking mechanisms can be rotated 90° by lifting the mounting assembly piece and rotating it before placing it on the pins.

The stretcher can be loaded on the gurney as necessitated by the placement of the mounting assemblies. A head-on mounting would occur as described in Example 1. A lateral mounting would be necessary if one of the locking mechanisms is located to the side. For a lateral mounting, the head of the stretcher would be guided toward the keyhole locking mechanism with the insert posts level with the locking mechanisms. The stretcher would be oriented such that the central axis of the payload mounting platform formed an acute angle with the longitudinal axis of the mounting assembly. The head-side insert post would be guided forward until it secured in to the keyhole locking mechanism. The stretcher would then be rotated toward the second keyhole locking mechanism until the second insert post locked in to place. The stretcher would then be securely attached to the gurney.

### Example 3

### Airplane Stretcher System

A modular payload stretcher system could be used to convert a bench seat on a private jet in to a patient care area. The system would largely follow the assemblies of Examples 1 and 2, with the bench seat utilized as a base support. The bench seat would offer the advantage of having extensional adjustment to allow the proximity of the stretcher to the cabin wall to be adjusted. The velcro-fastened cushions of the couch could be removed to reveal a horizontal surface for affixing the mounting assemblies. The velcro for securing the couch cushions could also be used to secure the mounting assembly pieces. The bench seat top surface would be modified with guide insert posts that ensure the proper positioning of the mounting assemblies. Due to the cabin wall, one of the locking mechanisms would need to be oriented with the locking mechanism directed away from the wall. The stretcher would be loaded on to the mounting assemblies by a lateral method as described in Example 2.

### Example 4

### Ambulance to Plane Stretcher Transfer

A patient is secured to a stretcher using the leg restraints and the chest harness. The patient is loaded in to an ambulance according to the method described in Example 1. The patient is transported to a tarmac where a properly equipped medical transport jet is waiting. The stretcher is released from the mounting assembly and carried out of the rear doors of the ambulance. The mounting assembly plates are removed from the ambulance base support and are affixed to a waiting gurney on the tarmac. The patient is loaded laterally on to the gurney until the stretcher is secured. The patient is wheeled to the medical jet and brought in via a rear cargo door. In the jet, the stretcher is released from the gurney. The mounting assemblies are removed from the gurney and are placed on the cushionless bench seat according to the guide inserts. A sideboard is placed on the vertical backboard of the bench seat. The patient is loaded laterally on to mounting assemblies until the stretcher is secured. Side cushions are placed to increase the bed surface. The patient has now been transferred through three modes of transportation via a single modular payload system.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered.

What is claimed is:

1. A modular payload transport system comprising:
a base support configured to be releasably coupled to a mounting assembly via a first coupling;
said mounting assembly configured to be releasably coupled to said base support via said first coupling and configured to be releasably coupled to a payload mounting platform via a second coupling; and
said payload mounting platform configured to be releasably coupled to said mounting assembly and configured to retain a portable payload;
wherein said base support, said mounting assembly, and said payload mounting platform are connected to form a modular payload transport system.

2. The modular payload transport system of claim 1, wherein said modular payload system further comprises a transportation vehicle.

3. The modular payload transport system of claim 2, wherein said transportation vehicle comprises a motor vehicle, aircraft, or sea vessel.

4. The modular payload transport system of claim 3, wherein said aircraft comprises a private jet airplane.

5. The modular payload transport system of claim 1, wherein said mounting assembly may be releasably coupled to a first base support or a second base support, wherein said base support differs from said second base support.

6. The modular payload transport system of claim 1, wherein said base support comprises an airplane bench seat.

7. The modular payload transport system of claim 1, wherein said payload mounting platform comprises a medical stretcher.

8. The modular payload transport system of claim 7, further comprising said portable payload.

9. The modular payload transport system of claim 8, wherein said portable payload comprises a medical patient.

10. The modular payload transport system of claim 1, wherein said portable payload comprises cargo, a scientific instrument, or a medical device.

11. The modular payload transport system of claim 2, wherein said base support further comprises an electrical outlet, wherein said electrical outlet is connected to an electrical power supply from said transportation vehicle.

12. The modular payload transport system of claim 1, wherein said coupling comprises a first base coupling and a second base coupling.

13. The modular payload transport system of claim 12, wherein said mounting assembly comprises a first insert post configured to connect to the first coupling, and a second insert post configured to connect to the second coupling.

14. A method of securing a payload unit to form a modular payload transport system, the method comprising:
providing a base support comprising a first coupling and a second coupling;
providing a payload unit comprising a mounting assembly and a payload mounting platform;
connecting said payload unit to said first coupling; and
connecting the payload unit to said second coupling; thereby securing said payload unit to said base support to form a modular payload transport system.

15. The method of claim 14, wherein said mounting assembly comprises a first insert post and a second insert post.

16. The method of claim 15, wherein said first insert post connects to said first coupling, and said second insert post secures to said second coupling.

17. The method of claim 16, wherein said connecting said payload unit to said first coupling comprises connecting said first insert post to said first coupling.

18. The method of claim 16, wherein said connecting said payload unit to said second coupling comprises connecting said second insert post to said second coupling.

19. The method of claim 14, wherein said connecting said payload unit to said first coupling occurs before said connecting said payload unit to said second coupling.

20. The method of claim 14, wherein said connecting said payload unit to said first coupling occurs simultaneously with said connecting said payload unit to said second coupling.

21. The method of claim 15, wherein said connecting said payload unit to said second coupling comprises:
rotating said payload unit about said first insert post; and
connecting said second insert post to said second coupling.

22. The method of claim 15, further comprising disconnecting said first insert post from said first coupling or disconnecting said second insert post from said second coupling.
